(19) United States
(12) Patent Application Publication
(10) Pub. No.: US 2009/0319656 A1
(43) Pub. Date: Dec. 24, 2009

(54) APPARATUS AND METHOD FOR MANAGING A NETWORK

(76) Inventors: Chen-Yui Yang, Marlboro, NJ (US); James Gordon Beattie, Bergenfield, NJ (US); Sunil Srinivasmurthy, Howell, NJ (US); Chao-Chun Luo, Colts Neck, NJ (US); Daniel A. Zuckerman, Holmdel, NJ (US)

Correspondence Address: AT&T Legal Department - AS;Attn: Patent Docketing, Room 2A-207, One AT&T Way, Bedminster, NJ, 07921, US

(21) Appl. No.: 12/145,182

(22) Filed: Jun. 24, 2008

(51) Int. Cl. G06F 15/173

(52) U.S. Cl. 709/224

(57) ABSTRACT

A system that incorporates teachings of the present disclosure may include, for example, a server having a controller to perform a first query of a network device by way of a wired connection with the network device, perform a second query of the network device by way of a wireless connection with the network device, detect an undesired condition associated with at least one of the network device and the wired connection with the network device based at least in part on the first and second queries, and discern between the undesired condition being associated with the network device and being associated with the wired connection based at least in part on the first and second queries. Other embodiments are disclosed.

### FIELD OF THE DISCLOSURE

The present disclosure relates generally to communication systems and more specifically to an apparatus and method for managing a network.

### BACKGROUND

Communication networks can be subject to various undesired conditions that can have an adverse impact on customers, such as disabling connections. The cause of such undesired conditions can vary, including equipment failure. Providing alerts associated with particular equipment may give a service provider a tool with which to monitor the particular equipment.

However, these alerts can result in false detections of equipment failure, such as where a busy network having network latency triggers an alert for a particular piece of equipment. The issuance of false detections of equipment failure can be exacerbated by routing protocol where customer traffic has priority over network management traffic.

### BRIEF DESCRIPTION OF THE DRAWINGS

FIGS. 1-4 depict exemplary embodiments of communication systems that provide media services;

FIG. 5 depicts an exemplary embodiment of a portal interacting with at least one among the communication systems of FIGS. 1-4 and 6-7;

FIGS. 6-7 depict exemplary embodiments of communication systems that provide media services;

FIG. 8 depicts an exemplary method operating in portions of the communication systems of FIGS. 1-4 and 6-7; and

FIG. 9 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a computer-readable storage medium comprising computer instructions for performing a first query of a network device by way of a wired connection with the network device where the first query is transmitted from a first query source, performing a second query of the network device by way of a wireless connection with the network device, detecting an undesired condition associated with at least one of the network device and the wired connection with the network device based at least in part on the first and second queries, associating the undesired condition with the wired connection when a response is received to the second query and no response is received to the first query, performing a third query of the network device by way of a portion of the wired connection with the network device where the third query is transmitted from a second query source, and associating the undesired condition with the portion of the wired connection when no response is received to the third query.

Another embodiment of the present disclosure entails a server comprising a controller to perform a first query of a network device by way of a wired connection with the network device, perform a second query of the network device by way of a wireless connection with the network device, detect an undesired condition associated with at least one of the network device and the wired connection with the network device based at least in part on the first and second queries, and discern between the undesired condition being associated with the network device and being associated with the wired connection based at least in part on the first and second queries.

Yet another embodiment of the present disclosure entails a server comprising a controller to monitor for first and second telemetry messages from a network device where the first telemetry message is communicated by way of a wired connection with the network device and the second telemetry message is communicated by way of a wireless connection with the network device, detect an undesired condition associated with at least one of the network device and the wired connection with the network device based at least in part on the monitoring for the first and second telemetry messages, and discern between the undesired condition being associated with the network device and being associated with the wired connection based at least in part on the monitoring of the first and second telemetry messages.

Yet another embodiment of the present disclosure entails a network device comprising a controller to receive a first query from a server by way of a wired connection with the server, transmit a first telemetry message to the server based on receipt of the first query, receive a second query from the server by way of a wireless connection with the server, and transmit a second telemetry message to the server based on receipt of the second query, where an undesired condition is detected for at least one of the network device and the wired connection with the network device based at least in part on the first and second queries, and where the undesired condition is discerned between being associated with the network device and being associated with the wired connection based at least in part on the first and second queries.

Yet another embodiment of the present disclosure entails a method of managing a network comprising monitoring for first and second telemetry messages from a network device where the first telemetry message is communicated by way of a wired connection with the network device and the second telemetry message is communicated by way of a wireless connection with the network device, detecting an undesired condition associated with at least one of the network device and the wired connection with the network device based at least in part on the monitoring for the first and second telemetry messages, and discerning between the undesired condition being associated with the network device and being associated with the wired connection based at least in part on the monitoring of the first and second telemetry messages.

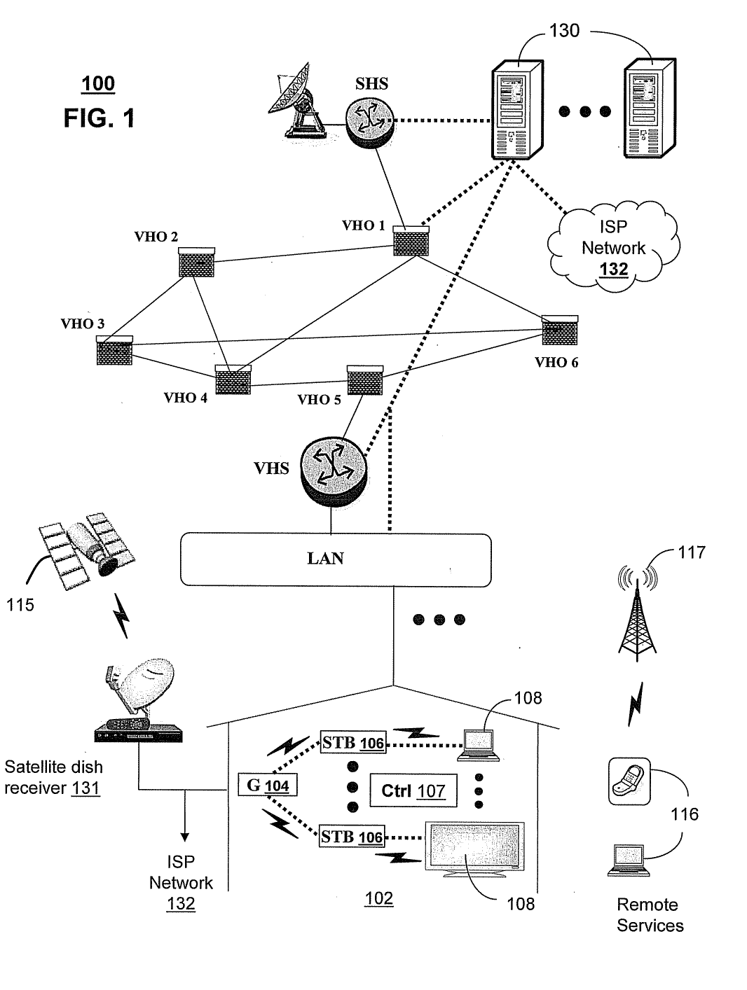

FIG. 1 depicts an exemplary embodiment of a first communication system 100 for delivering media content. The communication system 100 can represent an Internet Protocol Television (IPTV) broadcast media system. In a typical IPTV infrastructure, there is at least one super head-end office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as Set-Top Boxes (STBs) which in turn present broadcast selections to media devices 108 such as computers or television sets managed in some instances by a media controller 107 (e.g., an infrared or RF remote control). Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and present multicast or unicast media content.

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.).

A satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems such as cable TV systems.

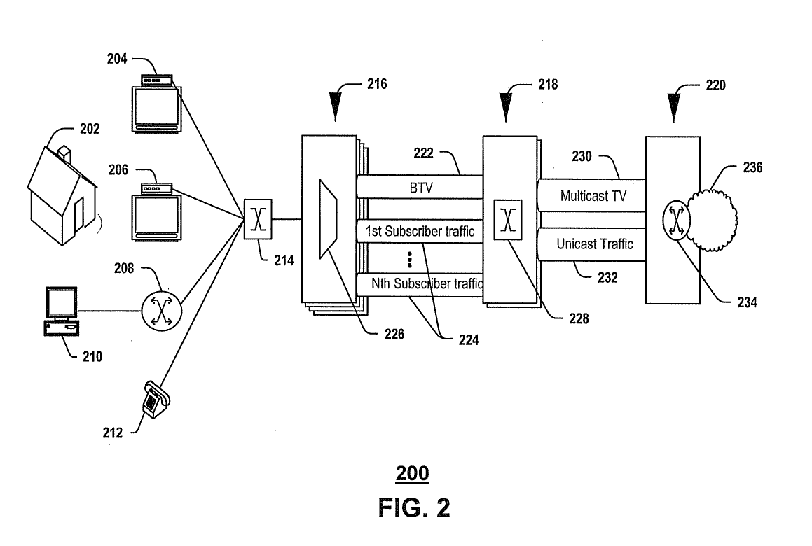

FIG. 2 depicts an exemplary embodiment of a second communication system 200 for delivering media content. Communication system 200 can be overlaid or operably coupled with communication system 100 as another representative embodiment of said communication system. The system 200 includes a distribution switch/router system 228 at a central office 218. The distribution switch/router system 228 receives video data via a multicast television stream 230 from a second distribution switch/router 234 at an intermediate office 220. The multicast television stream 230 includes Internet Protocol (IP) data packets addressed to a multicast IP address associated with a television channel. The distribution switch/router system 228 can cache data associated with each television channel received from the intermediate office 220.

The distribution switch/router system 228 also receives unicast data traffic from the intermediate office 220 via a unicast traffic stream 232. The unicast traffic stream 232 includes data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, receives a channel change command from an input device, such as a remoter control device. The channel change command can indicate selection of an IPTV channel. After receiving the channel change command, the set-top box device 204 generates channel selection data that indicates the selection of the IPTV channel. The set-top box device 204 can send the channel selection data to the access switch/router system 226 via the residential gateway 214.

The system 200 can include a number of features which may or may not be used with the components and techniques that monitor for problems associated with the system and which as described again later. For instance, the channel selection data can include an Internet Group Management Protocol (IGMP) Join request. In an illustrative embodiment, the access switch/router system 226 can identify whether it is joined to a multicast group associated with the requested channel based on information in the IGMP Join request. If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

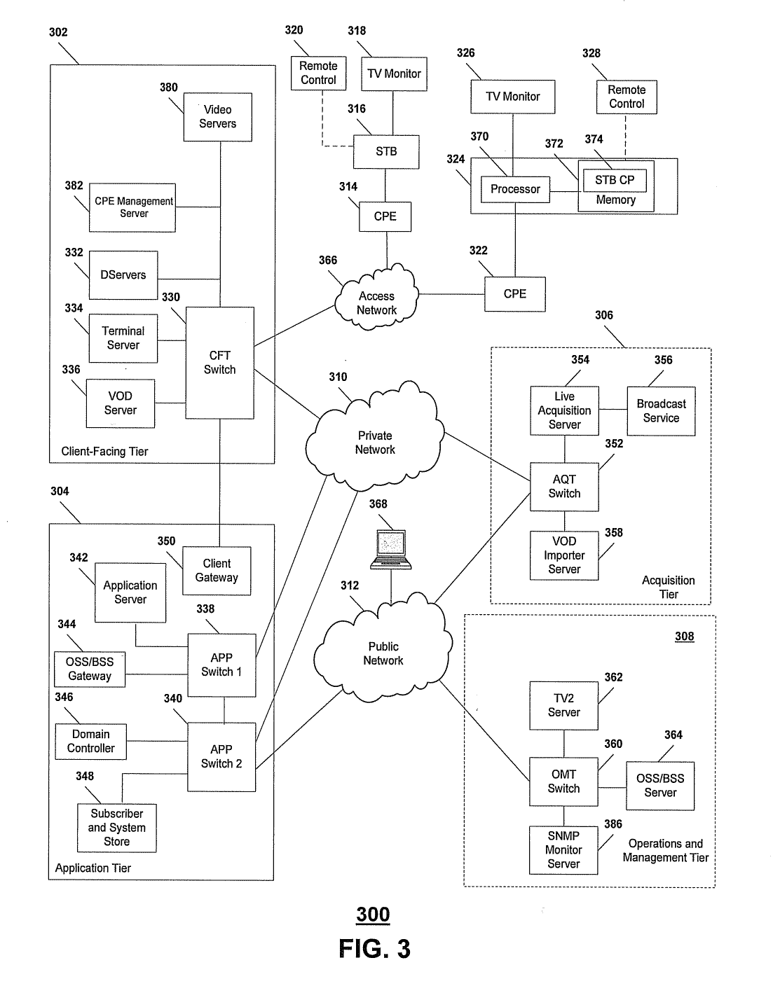

FIG. 3 depicts an exemplary embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 is coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 312.

As illustrated in FIG. 3, the various tiers 302, 304, 306, 308 communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an exemplary embodiment, the client-facing tier 302 can be coupled to the CPE 314, 322 via fiber optic cables. In another exemplary embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a VoD server 336 that stores or provides VoD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VoD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VoD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VoD server 336 at the client-facing tier 302 via the private network 310. Additionally, at the acquisition tier 306, the VoD importer server 358 can receive content from one or more VoD sources outside the IPTV system 300, such as movie studios and programmers of non-live content. The VoD importer server 358 can transmit the VoD content to the AQT switch 352, and the AQT switch 352, in turn, can communicate the material to the CFT switch 330 via the private network 310. The VoD content can be stored at one or more servers, such as the VoD server 336.

When users issue requests for VoD content via the set-top box devices 316, 324, the requests can be transmitted over the access network 366 to the VoD server 336, via the CFT switch 330. Upon receiving such requests, the VoD server 336 can retrieve the requested VoD content and transmit the content to the set-top box devices 316, 324 across the access network 366, via the CFT switch 330. The set-top box devices 316, 324 can transmit the VoD content to the television monitors 318, 326. In an illustrative embodiment, video or audio portions of VoD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

It should be apparent to one of ordinary skill in the art from the foregoing media communication system embodiments that other suitable media communication systems for distributing broadcast media content as well as peer-to-peer exchange of content can be applied to the present disclosure.

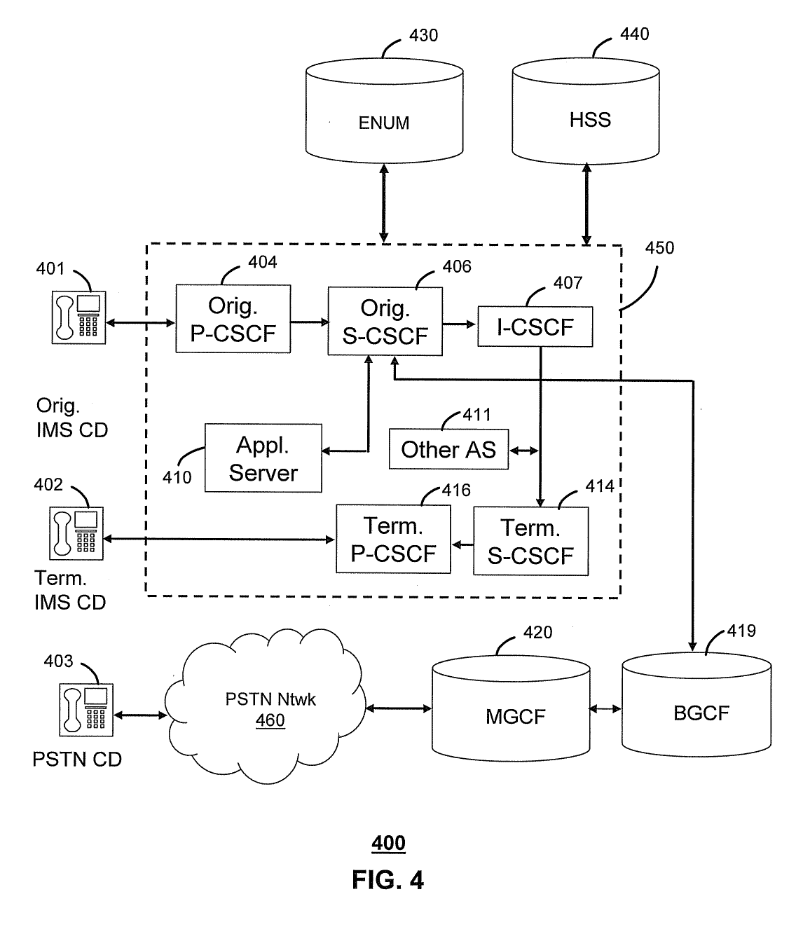

FIG. 4 depicts an exemplary embodiment of a communication system 400 employing an IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) supported by the HSS 440. To accomplish a communication session between CDs, an originating IMS CD 401 can submit a Session Initiation Protocol (SIP INVITE) message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E.164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (BGCF) 419.

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process is symmetrical. Accordingly, the terms “originating” and “terminating” in FIG. 4 can be interchanged.

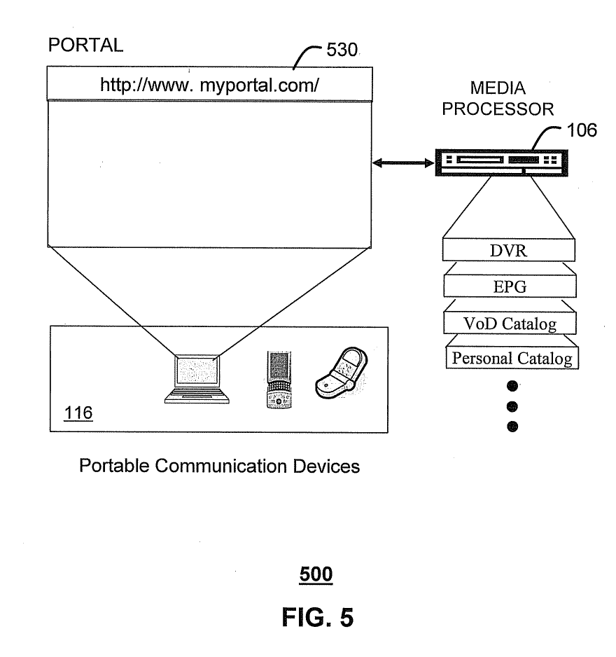

FIG. 5 depicts an exemplary embodiment of a portal 530. The portal 530 can be used for managing services of communication systems 100-400. The portal 530 can be accessed by a Uniform Resource Locator (URL) with a common Internet browser such as Microsoft's Internet Explorer using an Internet-capable communication device such as references 108, 116, or 210 of FIGS. 1-2. The portal 530 can be configured to access a media processor such as references 106, 204, 206, 316, and 324 of FIGS. 1-3 and services managed thereby such as a Digital Video Recorder (DVR), an Electronic Programming Guide (EPG), VoD catalog, a personal catalog stored in the STB (e.g., personal videos, pictures, audio recordings, etc.), and so on.

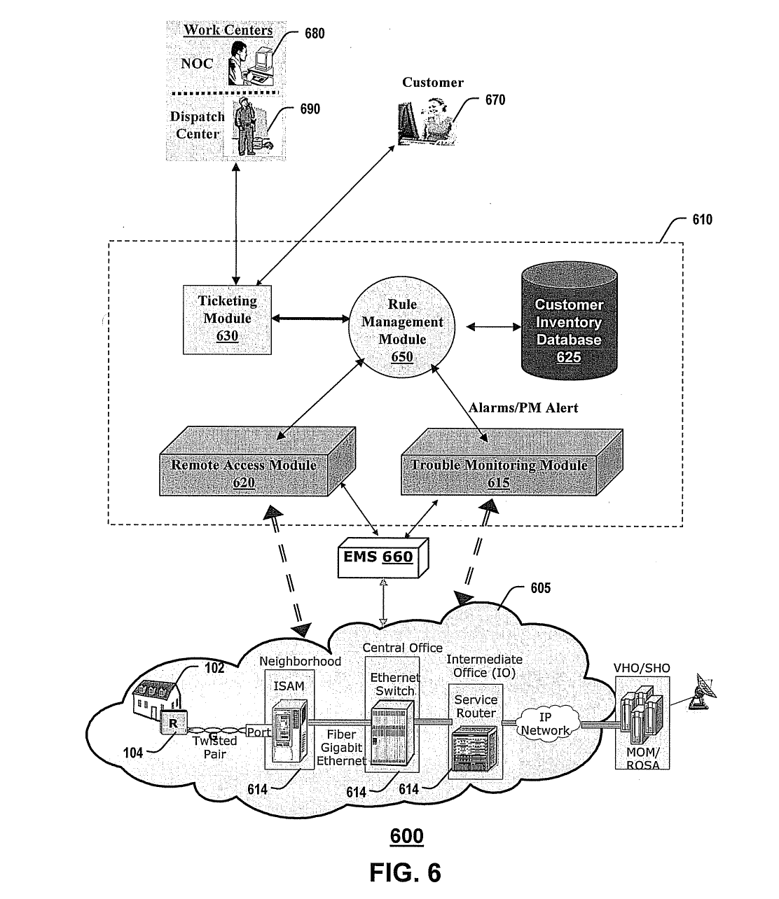

FIG. 6 depicts an exemplary embodiment of a communication system 600 for delivering media content. The communication system 600 can represent an IPTV broadcast media system. Communication system 600 can be overlaid or operably coupled with communication systems 100-400 as another representative embodiment of said communication systems.

System 600 can include a network 605 for delivery of the media content between the provider equipment (e.g., located at the video head office) and the customer's equipment (e.g., a gateway 104 located at a residence 102). A number of network devices 614, including service routers and Ethernet switches, can be utilized for transporting the signals along the network 605. The network 605 can utilize a number of connection structures for providing a communication link between the network devices 614, including twisted pair lines, fiber lines and/or wireless connections.

System 600 can include a management or monitoring system 610 operably connected to the network 605 and in communication with one or more of the network devices 614 therein. The management system 610 or portions thereof can be in communication with portions of the network 605 by way of both wired and wireless links. The management system 610 can include a trouble monitoring module (TMM) 615, a remote access module (RAM) 620, a customer inventory database 625, and a ticketing module 630 that are each in communication with a rule management module 650 (RMM). As will be discussed again later, the RMM 650 is in communication with each of the modules 615, 620 and 630 and the database 625 in order to perform a number of functions, including communication of queries (e.g., pings) with the network devices 614; determining device-based failures in comparison to connection-based failures; performing restoration procedures; confirming resolution of problems; notifying customers and/or network management personnel; and/or dispatching repair personnel to correct failures. The ticketing module 630 can be in communication with one or more of customers 670, work centers 680, and dispatch centers 690. It should be understood by one of ordinary skill in the art that the modules 615, 620, 630 and 650 and the database 625 can be separate components of the management system 610 or one or more of these components can be incorporated together.

In one embodiment, the management system 610 can be in communication with an event management system (EMS) 660 so that signals from one or more of the modules 615, 620, 630 and 650 are centrally distributed to the network devices 614. The EMS 660 can be coupled to the network 605 by way of a hardwire connection. It should be further understood by one of ordinary skill in the art that other configurations for communication between the management system 610 and the network 605 are also contemplated including a decentralized system and/or a master-slave arrangement between intermediary communication devices coupling the network 605 with the management system 610. One or more of the components of the management system 610, such as the TMM 615 and the RAM 620, can also be in wireless communication with the network 605.

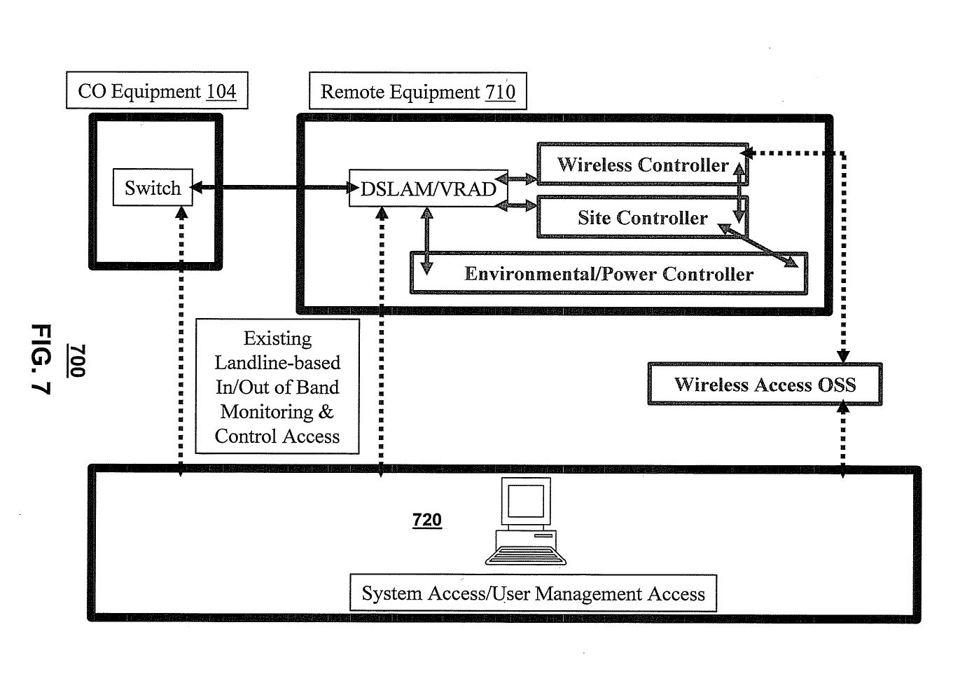

FIG. 7 depicts an exemplary embodiment of a communication system 700 for delivering media content. The communication system 700 can represent a portion of an IPTV broadcast media system. Communication system 700 can be overlaid or operably coupled with communication systems 100-400 and 600 as another representative embodiment of said communication systems.

System 700 can include customer equipment, such as a gateway 104 or other network device, including switches, routers, and so forth. The system 700 can also include remote equipment 710, including DSLAMs, wireless controllers, site controllers, environmental controllers, power controllers, and/or wireless access operating system components. The system 700 can include a management device 720 in communication with the remote equipment 710.

Remote equipment 710 can provide independent wireless-based management access capability that can be utilized in combination with wired-based management access capability. For example, alarms can be received by the user management device 720 from the DSLAM of the remote equipment 710 via the wireless controller and wireless access operating system. Performance data can be obtained by the user management device 720 from the DSLAM of the remote equipment 710 via the wireless controller and wireless access operating system. Restoration actions can be exercised by the user management device 720, such as upon the DSLAM of the remote equipment 710 via the wireless controller and wireless access operating system.

The remote equipment 710 can be implemented to perform tasks or other functions, including restoration of one or more network devices. For instance, the remote equipment 710 can include one or more components that perform environmental control with respect to the network devices, perform power supply control with respect to the network devices, and/or perform physical resets. The control exerted over the network devices can be implemented through one or both of wireless communication and wired communication with the network device.

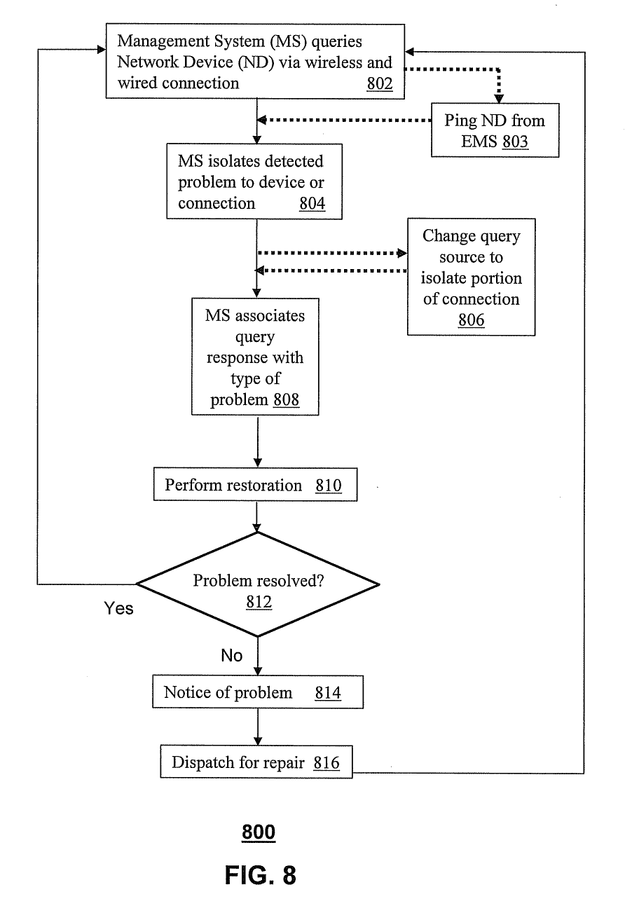

FIG. 8 depicts an exemplary method 800 operating in portions of the communication systems 100, 200, 300, 400, 600 and/or 700. Method 800 has variants as depicted by the dashed lines. It would be apparent to an artisan with ordinary skill in the art that other embodiments not depicted in FIG. 8 are possible without departing from the scope of the claims described below.

Method 800 can begin with step 802 in which the management system 610 queries one or more network devices 614 that are associated with the network 605 via both of a wireless and wired signal. The queries can be wireless and wired polling signals, such as Internet Control Message Protocol (ICMP) echo request packets (“pings”), which are transmitted to the same network device 614. In one embodiment, the wireless and wired query signals are transmitted to the network device 614 in temporal proximity, although the present disclosure contemplates use of a delay in transmitting one of the pings, such as to allow the network device to respond to each ping in series. In another embodiment, the wired pings are transmitted to the network device 614 from the EMS 660 at the request of the TMM 615 of the management system 610 as in step 803. In another embodiment, the wireless pings are sent from the TMM 615 to the network device 614, such as in parallel with or temporal proximity to the transmitting of the wired ping from the EMS 660 to the network device.

In one embodiment, in response to the queries, telemetry messages can be sent by the network device. The telemetry messages can include a connection confirmation, a round-trip time and/or a rate of packet loss, as well as other telemetry data associated with the network devices, such as bandwidth usage, environmental conditions and so forth. The network devices can have components capable of gathering this information, including sensors and the like.

In step 804, the management system 610 can detect a problem or other undesirable condition with respect to a device and the connection to the device. Through discrimination of the wireless query and wired query, the management system 610 can isolate the problem as being associated with the wired connection to the device 614 or as being associated with the device itself. For instance, where the query includes wireless and wired pings and both the pings fail, then the problem can be isolated to the device 614 or if the wireless ping is satisfactory and the wired ping fails, then the problem can be isolated to the cable or other connection to the device.

In one embodiment in step 806, the management system 610 can adjust the source of the query, such as the ping source, in order to determine a particular connection to a network device 614 that is a problem. For example, the management system 610 can initially utilize a more remote source to transmit the ping to the device 614 and if a problem in the connection is detected then the management system can then utilize a source in proximity to the device so as to isolate the particular link of the hardwire that is a problem. As another example, querying of network devices on a border of the network may be done by the EMS 660 to determine if there is a connection failure, while internal network devices may be queried by an internal query source so that a single hardwire connection is utilized to transmit the query to the network device. Any number of query sources can be used in order to isolate the undesired condition to a particular portion of the wired connection, such as where there are a plurality of legs of the connection and a plurality of query sources are utilized for isolating the failure.

In step 808, the management system 610 can associate or correlate the query response with a particular type of failure or undesirable condition. In one embodiment, the management system 610 can correlate an alarm received for a particular network device 614 with historical data associated with that network device, including customer data. Based on an association or correlation determined between the alarm and the historical data, a particular type of failure can be determined. For instance, correlation between customer data and an alarm can be utilized to determine or predict device or connection failures due to undesired logical, environmental and/or power conditions. Data from other customers currently sharing that device or utilizing that connection can be correlated with the alarm for determining or predicting the type of failure.

In step 810, the management system 610 can perform restoration operations with respect to a detected failure or undesired condition with respect to the device or connection to the device. For example, the management system 610 can perform physical resets on the network device 614 having the detected problem. The management system 610 can utilize wireless controllers, site controllers, environmental controllers and/or power controllers to make adjustments with respect to the device to restore it to a desired condition. For instance, if a problem is detected and it is correlated with a thermal management problem, the environmental controller can respond by performing thermal management operations (e.g., increasing device fan speed, lowering room temperature, and so forth). Other restoration steps can be performed as well, including sharing the device's load with other network devices.

In step 812, the management system 610 can determine if the restoration operations were successful with respect to the network device. This can be done through queries to the network device that are wireless and/or wired or other communication techniques. If the resolution operations for the network device have been successful then method 600 can return to step 802 to continue monitoring one or more of the network devices via the wired and wireless queries. If on the other hand, the restoration operations were not successful then in step 814 the management system 610 can transmit a notice of the detected problem to the provider's work center 680 and/or the customer 670. The type of problem detected (e.g., expected duration, possible resolutions, and so forth) can determine if one or both of the work center and the customer receives the notice. In step 816, if the detected problem requires the service personnel to perform the resolution operation (e.g., a cut in the communication line, a router failure, and so forth) then a dispatch notice can be transmitted to the dispatch center 690 so that the service personnel can respond. Method 800 can then return to step 802 to continue monitoring one or more of the network devices via the wired and wireless queries.

From the foregoing descriptions, it would be evident to an artisan with ordinary skill in the art that the aforementioned embodiments can be modified, reduced, or enhanced without departing from the scope and spirit of the claims described below. For example, other network devices can be polled for connectivity information, including gateways, switches and hubs. As another example, the network devices can forward wireless and wired connectivity and/or telemetry data to the management system 610 without requiring a query from the management system. For instance, the network devices can have a schedule for forwarding the data via both wireless and wired signals. If the signals are not received according to the schedule or within a time interval thereof then it can be determined whether either or both of the wired and wireless signals were received in order to discern if there is a problem with the connection or the device itself. In one embodiment, the time interval for receipt of the wired signals can be adjusted based on network load (e.g., increasing the time interval for historically or detected heavier customer bandwidth usage periods).

These are but a few examples of the modifications that can be applied to the present disclosure without departing from the scope of the claims. Accordingly, the reader is directed to the claims for a fuller understanding of the breadth and scope of the present disclosure.

Other suitable modifications can be applied to the present disclosure without departing from the scope of the claims below. Accordingly, the reader is directed to the claims section for a fuller understanding of the breadth and scope of the present disclosure.

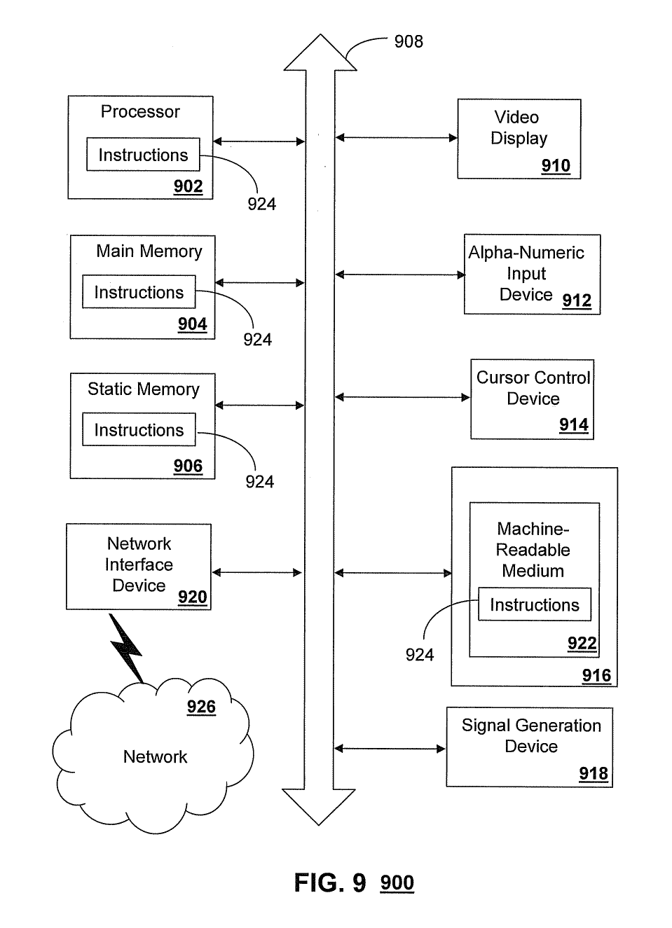

FIG. 9 depicts an exemplary diagrammatic representation of a machine in the form of a computer system 900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium comprising computer instructions for:
performing a first query of a network device by way of a wired connection with the network device, the first query being transmitted from a first query source;
performing a second query of the network device by way of a wireless connection with the network device;
detecting an undesired condition associated with at least one of the network device and the wired connection with the network device based at least in part on the first and second queries;
associating the undesired condition with the wired connection when a response is received to the second query and no response is received to the first query;
performing a third query of the network device by way of a portion of the wired connection with the network device, the third query being transmitted from a second query source; and
associating the undesired condition with the portion of the wired connection when no response is received to the third query.

2. The storage medium of claim 1, comprising computer instructions for associating the undesired condition with the network device when no response is received to the first query and no response is received to the second query.

3. The storage medium of claim 1, comprising computer instructions for transmitting the first and second queries in temporal proximity with each other.

4. The storage medium of claim 1, comprising computer instructions for transmitting the second query from a third query source that is different from the first query source.

5. The storage medium of claim 1, wherein at least one of the first, second and third queries comprise Internet Control Message Protocol echo request packets.

6. The storage medium of claim 1, comprising computer instructions for:
accessing customer data; and
associating the undesired condition with a type of problem based at least in part on the customer data.

7. The storage medium of claim 6, comprising computer instructions for:
performing a resolution operation on the network device based on the type of problem; and
verifying resolution of the undesired condition.

8. The storage medium of claim 1, wherein the first and second queries request information comprising at least one among a connection confirmation, a round-trip time and a rate of packet loss.

9. A server comprising a controller to:
perform a first query of a network device by way of a wired connection with the network device;
perform a second query of the network device by way of a wireless connection with the network device;
detect an undesired condition associated with at least one of the network device and the wired connection with the network device based at least in part on the first and second queries; and
discern between the undesired condition being associated with the network device and being associated with the wired connection based at least in part on the first and second queries.

10. The server of claim 9, wherein the controller is adapted to:
perform a third query of the network device by way of a portion of the wired connection with the network device, the first query being transmitted from a first query source, the third query being transmitted from a second query source; and
associate the undesired condition with the portion of the wired connection when no response is received to the third query.

11. The server of claim 9, wherein the first and second queries are transmitted in temporal proximity with each other.

12. The server of claim 10, wherein at least one of the first, second and third queries comprise Internet Control Message Protocol echo request packets.

13. The server of claim 9, wherein the controller is adapted to:
associate the undesired condition with a type of problem based at least in part on customer data;
perform a resolution operation on the network device based on the type of problem; and
verify resolution of the undesired condition.

14. A server comprising a controller to:
monitor for first and second telemetry messages from a network device, the first telemetry message being communicated by way of a wired connection with the network device, the second telemetry message being communicated by way of a wireless connection with the network device;
detect an undesired condition associated with at least one of the network device and the wired connection with the network device based at least in part on the monitoring for the first and second telemetry messages; and
discern between the undesired condition being associated with the network device and being associated with the wired connection based at least in part on the monitoring of the first and second telemetry messages.

15. The server of claim 14, wherein the first and second telemetry messages comprise at least one among a connection confirmation, a round-trip time and a rate of packet loss.

16. The server of claim 14, wherein the first and second telemetry messages are transmitted by the network device according to a schedule, and wherein the monitoring for the first and second telemetry messages is based at least in part on the schedule.

17. The server of claim 14, wherein the controller is adapted to:
perform a first query of the network device by way of the wired connection with the network device, the first telemetry message being sent in response to the first query; and
perform a second query of the network device by way of the wireless connection with the network device, the second telemetry message being sent in response to the second query.

18. The server of claim 17, wherein the controller is adapted to:
perform a third query of the network device by way of a portion of the wired connection with the network device, the first query being transmitted from a first query source, the third query being transmitted from a second query source; and
associate the undesired condition with the portion of the wired connection when no response is received to the third query.

19. The server of claim 17, wherein the first and second queries are transmitted in temporal proximity with each other.

20. The server of claim 14, wherein the controller is adapted to:
associate the undesired condition with a type of problem based at least in part on customer data;
perform a resolution operation on the network device based on the type of problem; and
verify resolution of the undesired condition.

21. A network device comprising a controller to:
receive a first query from a server by way of a wired connection with the server;
transmit a first telemetry message to the server based on receipt of the first query;
receive a second query from the server by way of a wireless connection with the server; and
transmit a second telemetry message to the server based on receipt of the second query,
wherein an undesired condition is detected for at least one of the network device and the wired connection with the network device based at least in part on the first and second queries, and wherein the undesired condition is discerned between being associated with the network device and being associated with the wired connection based at least in part on the first and second queries.

22. The network device of claim 21, wherein the first and second telemetry messages comprise at least one among a connection confirmation, a round-trip time and a rate of packet loss.

23. A method of managing a network comprising:
monitoring for first and second telemetry messages from a network device, the first telemetry message being communicated by way of a wired connection with the network device, the second telemetry message being communicated by way of a wireless connection with the network device;
detecting an undesired condition associated with at least one of the network device and the wired connection with the network device based at least in part on the monitoring for the first and second telemetry messages; and
discerning between the undesired condition being associated with the network device and being associated with the wired connection based at least in part on the monitoring of the first and second telemetry messages.

24. The method of claim 23, comprising:
performing a first query of the network device by way of the wired connection with the network device, the first telemetry message being sent in response to the first query; and
performing a second query of the network device by way of the wireless connection with the network device, the second telemetry message being sent in response to the second query.

25. The method of claim 23, comprising:
performing a third query of the network device by way of a portion of the wired connection with the network device, the first query being transmitted from a first query source, the third query being transmitted from a second query source; and
associating the undesired condition with the portion of the wired connection when no response is received to the third query.
